(19) United States
(12) Patent Application Publication
(10) Pub. No.: US 2025/0106807 A1
(43) Pub. Date: Mar. 27, 2025

(54) POSITIONING OF WIRELESS DEVICE

(71) Applicant: GUANGDONG OPPO MOBILE TELECOMMUNICATIONS CORP., LTD., Dongguan (CN)

(72) Inventor: Hao LIN, NEUILLY-SUR-SEINE (FR)

(21) Appl. No.: 18/973,385

(22) Filed: Dec. 9, 2024

Related U.S. Application Data
(63) Continuation of application No. PCT/IB2022/000610, filed on Sep. 29, 2022.

(51) Int. Cl. H04W 64/00; H04L 5/00; H04W 24/10; H04W 56/00

(52) U.S. Cl. CPC H04W 64/00; H04L 5/0048; H04W 24/10; H04W 56/0045

(57) ABSTRACT

An apparatus and methods of wireless communication are provided. The method of wireless communication by a UE includes at least one of the followings: performing, by the UE, a transmission of a first signal and/or a second signal from and/or to a network device, performing, by the UE, a positioning measurement based on the first signal and/or the second signal, or reporting, by the UE, an assistance information to the network device.

### CROSS-REFERENCE TO RELATED APPLICATION

This application is a continuation of International Patent Application No. PCT/IB2022/000610, filed on Sep. 29, 2022, the disclosure of which is hereby incorporated by reference in its entirety.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as long term evolution (LTE) systems, LTE-advanced (LTE-A) systems, or LTE-A pro systems, and fifth generation (5G) systems which may be referred to as new radio (NR) systems. These systems may employ technologies such as code division multiple access (CDMA), time division multiple access (TDMA), frequency division multiple access (FDMA), orthogonal frequency division multiple access (OFDMA), or discrete Fourier transform spread orthogonal frequency division multiplexing (DFT-S-OFDM). A wireless multiple-access communications system may include a number of base stations or network access nodes, each simultaneously supporting communication for multiple communication devices, which may be otherwise known as user equipment (UE).

### SUMMARY

The present disclosure relates to the field of communication systems, and more particularly, to methods of wireless communication, and a UE.

In a first aspect of the present disclosure, a method of wireless communication by a UE includes at least one of the followings: performing, by the UE, a transmission of a first signal and/or a second signal from and/or to a network device; performing, by the UE, a positioning measurement based on the first signal and/or the second signal; or reporting, by the UE, an assistance information to the network device.

In a second aspect of the present disclosure, a method of wireless communication by a network device includes at least one of the followings: performing, by the network device, a transmission of a first signal and/or a second signal from and/or to a user equipment (UE); performing, by the network device, a positioning measurement based on the first signal and/or the second signal; or detecting, by the network device, an assistance information reported by the UE.

In a third aspect of the present disclosure, a user equipment includes a memory, a transceiver, and a processor coupled to the memory and the transceiver. The processor is configured to perform the above method.

### BRIEF DESCRIPTION OF DRAWINGS

In order to illustrate the embodiments of the present disclosure or related art more clearly, the following figures will be described in the embodiments are briefly introduced. It is obvious that the drawings are merely some embodiments of the present disclosure, a person having ordinary skill in this field can obtain other figures according to these figures without paying the premise.

FIG. 1A is a schematic structural diagram of a communication system according to an embodiment of the present application.

FIG. 1B is a schematic structural diagram of another communication system according to an embodiment of the present application.

FIG. 1C is a schematic structural diagram of another communication system according to an embodiment of the present application.

FIG. 2 is a schematic diagram of a positioning scenario according to an embodiment of the present application.

FIG. 3 is a schematic diagram of a principle of a time difference of arrival (TDOA) positioning method according to an embodiment of the present application.

FIG. 4 is a block diagram of one or more user equipment (UEs) and a network device of communication in a communication network system according to an embodiment of the present disclosure.

FIG. 5 is a flowchart illustrating a method of wireless communication performed by a user equipment (UE) according to an embodiment of the present disclosure.

FIG. 6 is a flowchart illustrating a method of wireless communication performed by a network device according to an embodiment of the present disclosure.

FIG. 7 is a block diagram of a UE and a network device of communication in a communication network system (e.g., non-terrestrial network (NTN)) according to an embodiment of the present disclosure.

FIG. 8 is a block diagram of a UE and a network device of communication in a communication network system (e.g., non-terrestrial network (NTN)) according to an embodiment of the present disclosure.

FIG. 9A is a block diagram of a UE and a network device of communication in a communication network system (e.g., non-terrestrial network (NTN)) according to an embodiment of the present disclosure.

FIG. 9B is a block diagram of a UE and a network device of communication in a communication network system (e.g., non-terrestrial network (NTN)) according to an embodiment of the present disclosure.

FIG. 9C is a block diagram of a UE and a network device of communication in a communication network system (e.g., non-terrestrial network (NTN)) according to an embodiment of the present disclosure.

FIG. 9D is a block diagram of a UE and a network device of communication in a communication network system (e.g., non-terrestrial network (NTN)) according to an embodiment of the present disclosure.

FIG. 10 is a schematic diagram of a communication network system positioning according to an embodiment of the present disclosure.

FIG. 11 is a schematic diagram of a communication network system positioning according to an embodiment of the present disclosure.

FIG. 12 is a schematic diagram of a communication network system positioning according to an embodiment of the present disclosure.

FIG. 13 is a schematic diagram of a communication network system positioning according to an embodiment of the present disclosure.

FIG. 14 is a flowchart illustrating a communication network system positioning according to an embodiment of the present disclosure.

FIG. 15 is a flowchart illustrating a communication network system positioning according to an embodiment of the present disclosure.

FIG. 16 is a block diagram of a wireless communication device according to an embodiment of the present disclosure.

FIG. 17 is a block diagram of a wireless communication device according to an embodiment of the present disclosure.

FIG. 18 is a block diagram of a system for wireless communication according to an embodiment of the present disclosure.

### DETAILED DESCRIPTION OF EMBODIMENTS

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

The technical solutions of the embodiments of the present disclosure can be applied to various communication systems, such as a global system of mobile communication (GSM) system, a code division multiple access (CDMA) system, a wideband code division multiple access (WCDMA) system, a general packet radio service (GPRS), a long term evolution (LTE) system, a LTE frequency division duplex (FDD) system, a LTE time division duplex (TDD) system, an advanced long term evolution (LTE-A) system, a new radio (NR) system, an evolution system of a NR system, a LTE-based access to unlicensed spectrum (LTE-U) system, a NR-based access to unlicensed spectrum (NR-U) system, an universal mobile telecommunication system (UMTS), a global interoperability for microwave access (WiMAX) communication system, wireless local area networks (WLAN), wireless fidelity (Wi-Fi), a future 5G system (may also be called a new radio (NR) system) or other communication systems, etc.

Optionally, a network device or a network node mentioned in the embodiments of the present application can provide a communication coverage for a specific geographic area and can communicate with a terminal device located in the coverage area. Optionally, the network device may be a base transceiver station (BTS) in the GSM or in the CDMA system, or may be a NodeB (NB) in the WCDMA system, or may be an evolutional Node B (eNB or eNodeB) in the LTE system, or a radio controller in a cloud radio access network (CRAN). Alternatively, the network device may be a relay station, an access point, an in-vehicle device, a wearable device, a network-side device in a future 5G network, or a network device in a future evolved public land mobile network (PLMN).

A terminal device of implementations may be mobile or fixed. The terminal device may refer to an access terminal, a user equipment (UE), a subscriber unit, a subscriber station, a mobile station, a remote station, a remote terminal, a mobile device, a user terminal, a terminal, a wireless communication device, a user agent, or a user device. The access terminal may be a cellular radio telephone, a cordless telephone, a session initiation protocol (SIP) telephone, a wireless local loop (WLL) station, a personal digital assistant (PDA), a handheld device with wireless communication functions, a computing device, other processing devices coupled with a wireless modem, an in-vehicle device, a wearable device, a terminal device in a future 5G network, a terminal device in a future evolved PLMN, etc.

Optionally, the communication system in the embodiment of the present application may be applied to an unlicensed spectrum, where the unlicensed spectrum may also be considered as a shared spectrum; or the communication system in the embodiment of the present application may also be applied to a licensed spectrum, where the licensed spectrum can also be considered an unshared spectrum.

Optionally, the embodiments of the present application may be applied to a non-terrestrial network (NTN, non-terrestrial communication network) system or a terrestrial network (TN, terrestrial communication network) system.

As an example, in this embodiment of the present application, the network device may have a mobile feature, for example, the network device may be a mobile device. Optionally, the network device may be a satellite or a balloon station. For example, the satellite may be a low earth orbit (LEO) satellite, a medium earth orbit (MEO) satellite, a geostationary earth orbit (GEO) satellite, a high elliptical orbit (HEO) satellite, etc. Optionally, the network device may also be a base station set in a location such as land or water.

Communication system scenarios may include a TN and an NTN. The NTN may use satellite communication to provide communication services to terrestrial users. NTN systems currently include new radio (NR)-NTN systems and internet of things (IoT)-NTN systems.

In wireless communications systems, timing advance (TA) values corresponding to different times may be quite different. Therefore, there is a need for an apparatus and a method of wireless communication for positioning.

An object of the present disclosure is to propose an apparatus (such as a user equipment (UE) and/or a network device) and a method of wireless communication, which can provide a system positioning, reduce a network signaling, reduce a power consumption, provide a good communication performance, and/or provide a high reliability.

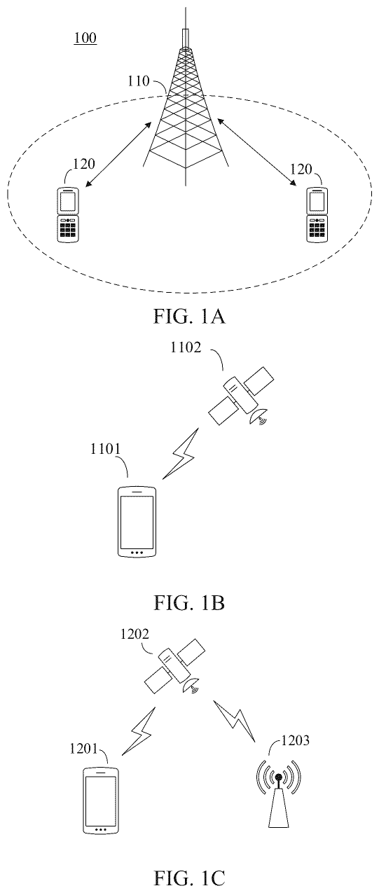

Exemplarily, FIG. 1A is a schematic structural diagram of a communication system according to an embodiment of the present application. As illustrated in FIG. 1A, a communication system 100 may include a network device 110, and the network device 110 may be a device that communicates with a terminal device 120 (or referred to as a communication terminal, a terminal). The network device 110 may provide a communication coverage for a particular geographic area and may communicate with terminal devices located within the coverage area. FIG. 1A exemplarily illustrates one network device and two terminal devices. In some embodiments, the communication system 100 may include multiple network devices, and the coverage of each network device may include other numbers of terminal devices, which is not limited in this embodiment of the present application.

Exemplarily, FIG. 1B is a schematic structural diagram of another communication system according to an embodiment of the present application. Referring to FIG. 1B, the communication system includes a terminal device 1101 and a satellite 1102, and wireless communication can be performed between the terminal device 1101 and the satellite 1102. The network formed between the terminal device 1101 and the satellite 1102 may also be referred to as NTN. In the architecture of the communication system illustrated in FIG. 1B, the satellite 1102 can function as a base station, and the terminal device 1101 and the satellite 1102 can communicate directly. Under the system architecture, the satellite 1102 may be referred to as a network device. Optionally, the communication system may include multiple network devices 1102, and the coverage of each network device 1102 may include other numbers of terminal devices, which are not limited in this embodiment of the present application.

Exemplarily, FIG. 1C is a schematic structural diagram of another communication system according to an embodiment of the present application. Referring to FIG. 1C, the communication system includes a terminal device 1201, a satellite 1202, and a base station 1203. The terminal device 1201 and the satellite 1202 can communicate wirelessly, and the satellite 1202 and the base station 1203 can communicate. The network formed between the terminal device 1201, the satellite 1202, and the base station 1203 may also be referred to as NTN. In the architecture of the communication system illustrated in FIG. 1C, the satellite 1202 may not have the function of the base station, and the communication between the terminal device 1201 and the base station 1203 needs to be relayed through the satellite 1202. Under such a system architecture, the base station 1203 may be referred to as a network device. In some embodiments of the present application, the communication system may include multiple network devices 1203, and the coverage of each network device 1203 may include other numbers of terminal devices, which are not limited in this embodiment of the present application.

In the NTN system, the network device needs to send a synchronization assistance information to the terminal device, where the synchronization assistance information is used for the terminal device to complete time domain and/or frequency domain synchronization. The synchronization assistance information is used to indicate at least one of the following information: a serving satellite ephemeris information, a common timing value such as timing advance (TA) parameter, a reference time indication information (epoch time, used to determine time t0), and a duration of a target timer.

The terminal device completes the corresponding time domain and/or frequency domain synchronization according to the synchronization assistance information and at the same time according to its own global navigation satellite system (GNSS) capability. The terminal device may obtain at least one of the following information based on its GNSS capabilities: a terminal device's location, a time reference, and a frequency reference. Furthermore, based on the above information and the information obtained from the synchronization assistance information, the terminal device can obtain a timing and/or frequency offset, and apply a timing advance compensation and/or a frequency offset adjustment in an idle state, an inactive state, or a connected state.

Because the satellite is moving, the synchronization assistance information may change with time. For example, the ephemeris information of a serving satellite may change with time. A public timing value such as a TA parameter can include: a public timing value, a public timing value offset value (such as the first derivative of the common timing value), a rate of change of the offset value of the common timing value (such as the second derivative of the common timing value), etc. The terminal device can determine the serving satellite ephemeris information at different times according to the synchronization assistance information and determine the public TA at different times, so as to obtain timing advance values at different times. That is to say, in the NTN system, the TA values corresponding to different times may be quite different.

In the NR system, the supported positioning methods include a downlink time difference of arrival (DL-TDOA) positioning method, an uplink TDOA (UL-TDOA) positioning method and a multi-round trip time (RTT) positioning method.

The propagation time of a signal is directly related to the propagation distance, so the deviation between the transmission times of the signals sent by multiple network nodes (TRPs) reaching the terminal also reflects the difference between the distances between multiple network nodes and the terminal. The basic principle of the DL-TDOA positioning method is to estimate the position of the terminal based on the transmission time deviation of the signals sent by multiple network nodes (transmission reception points, TRPs) arriving at the terminal and the known positions of the network nodes. The DL-TDOA positioning method is based on the one-way transmission of measurement signals between the network node TRP and the terminal, that is, the network node TRP sends a signal, and the terminal performs measurement.

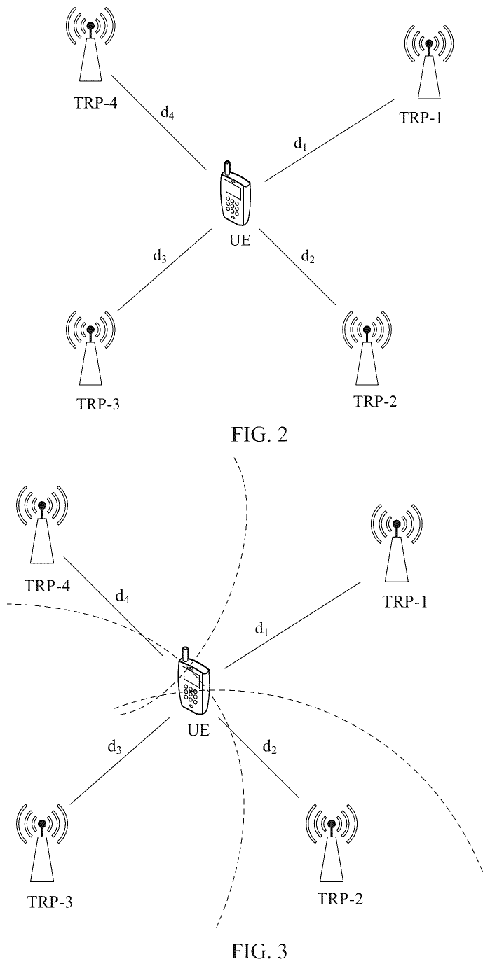

FIG. 2 is a schematic diagram of a positioning scenario according to an embodiment of the present application. The DL-TDOA positioning method is introduced below. As illustrated in FIG. 2, M=4 network nodes, which are respectively denoted as TRP 1, TRP 2, TRP 3 and TRP 4. The three-dimensional coordinates and the sending timing error corresponding to the network node TRP i (i=1, 2, . . . , M) are respectively denoted as (Xᵢ, yᵢ, Zᵢ) and tax. The three-dimensional coordinates corresponding to the terminal and the receiving timing error are respectively denoted as (XUE, YUE, ZUE) and TUE,i. The distance between the network node TRP i and the terminal is denoted as di, then the TOA is calculated as follows (where c represents the speed of light):

$${TOA}_{i} = \frac{\sqrt[2]{{( {x}_{i} - {x}_{UE} )}^{2} + {( {y}_{i} - {y}_{UE} )}^{2} + {( {z}_{i} - {z}_{UE} )}^{2}}}{c} + {τ}_{UE , i}^{Rx} - {τ}_{i}^{Tx} + {n}_{i} , i = 1 , 2 , … , M$$

In actual scenarios, by adopting high-precision devices and appropriate deployment methods, network nodes can generally achieve relatively good synchronization accuracy. Even if there is a small synchronization error, it generally does not significantly affect the positioning accuracy. Therefore, in general, we can assume τᵢ^{Tx}=0. In a period of time, the timing error of the same terminal changes very little, so it can be considered that in the above formula, τT_{UE,1}^{Rx} =τT_{UE,2}^{Rx} = . . . =τ_{UE,M}^{Rx}. The basic principle of the TDOA positioning method is to cancel out the relevant terms by taking the difference between the two estimated TOAs. Assuming that TRP 1 is used as a reference (at this time, TRP 1 is called the reference TRP) to calculate the TOA difference corresponding to different TRPs, M-1 constraint equations can be obtained:

$${TDOA}_{i , 1} = {TOA}_{i} - {TOA}_{1} = \frac{\sqrt[2]{{( {x}_{i} - {x}_{UE} )}^{2} + {( {y}_{i} - {y}_{UE} )}^{2} + {( {z}_{i} - {z}_{UE} )}^{2}}}{c} + {n}_{i} - \frac{\sqrt[2]{{( {x}_{i} - {x}_{UE} )}^{2} + {( {y}_{i} - {y}_{UE} )}^{2} + {( {z}_{i} - {z}_{UE} )}^{2}}}{c} - {n}_{1}$$

Equivalently, if there is an error between the UE side timing and the network side timing, it can be seen from the above formula that this error is also eliminated. In order to obtain a more reliable solution for the position information containing K (for example, 3) unknown variables, at least M>K+1 (for example, 4) network nodes are required.

FIG. 3 is a schematic diagram of a principle of a time difference of arrival (TDOA) positioning method according to an embodiment of the present application. Each equation in the system of equations (2) can be seen as a hyperbola with TRP i and TRP 1 as the foci. Therefore, the physical meaning of the TDOA positioning method can be intuitively understood by using FIG. 3: draw the corresponding hyperbola with each network node pair (TRP i, TRP 1) as the focus, and the position where these hyperbolas intersect is estimated by the TDOA positioning method as the terminal position. Due to factors such as estimation error, these hyperbolas usually do not cross perfectly at one point, but rather within a small area.

In the DL-TDOA positioning method, the terminal performs TDOA estimation based on the downlink positioning reference signal (PRS), and the corresponding estimation is called the downlink signal time difference (DL reference signal time difference, DL RSTD) in the NR protocol. DL RSTD is defined as the downlink relative timing difference Ti-TO between the i-th TRP and the reference TRP, where TO is the time corresponding to the start of a downlink subframe received by the terminal from the reference TRP, such as the start of the first downlink subframe. Ti is the time corresponding to the starting point of a downlink subframe, such as the second downlink subframe, received by the terminal from the i-th TRP, wherein the second downlink subframe is the subframe closest to the first downlink subframe. In addition, in the DL-TDOA positioning method, in addition to measuring and reporting the DL RSTD, the terminal may optionally report a reference signal received power (RSRP) value obtained based on the DL PRS measurement to assist the LMF to improve the accuracy of the position estimation.

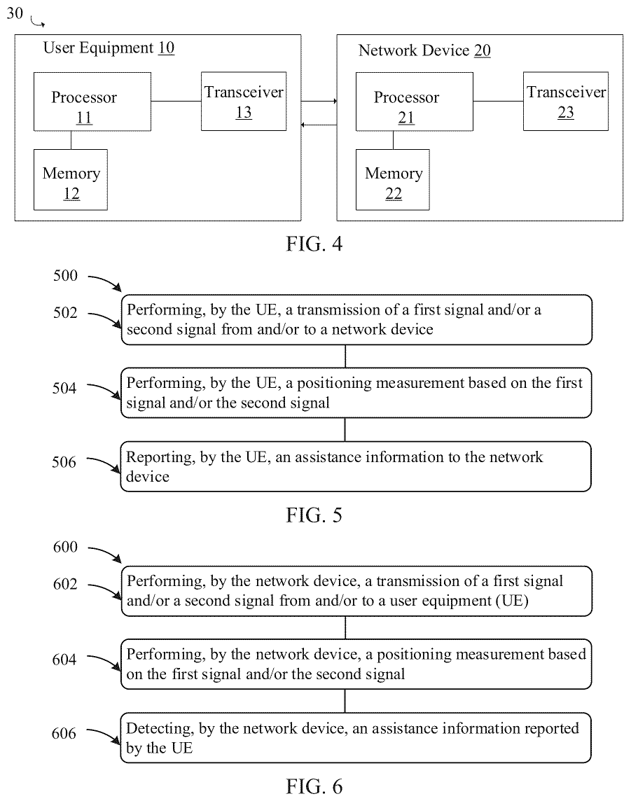

FIG. 4 illustrates that, in some embodiments, one or more user equipment (UEs) 10 and a network device 20 for transmission adjustment in a communication network system 30 (e.g., non-terrestrial network (NTN) or terrestrial network) according to an embodiment of the present disclosure are provided. The communication network system 30 includes the one or more UEs 10 and the network device 20. The one or more UEs 10 may include a memory 12, a transceiver 13, and a processor 11 coupled to the memory 12 and the transceiver 13. The network device 20 may include a memory 22, a transceiver 23, and a processor 21 coupled to the memory 22 and the transceiver 23. The processor 11 or 21 may be configured to implement proposed functions, procedures and/or methods described in this description. Layers of radio interface protocol may be implemented in the processor 11 or 21. The memory 12 or 22 is operatively coupled with the processor 11 or 21 and stores a variety of information to operate the processor 11 or 21. The transceiver 13 or 23 is operatively coupled with the processor 11 or 21, and the transceiver 13 or 23 transmits and/or receives a radio signal.

The processor 11 or 21 may include application-specific integrated circuit (ASIC), other chipset, logic circuit and/or data processing device. The memory 12 or 22 may include read-only memory (ROM), random access memory (RAM), flash memory, memory card, storage medium and/or other storage device. The transceiver 13 or 23 may include baseband circuitry to process radio frequency signals. When the embodiments are implemented in software, the techniques described herein can be implemented with modules (e.g., procedures, functions, and so on) that perform the functions described herein. The modules can be stored in the memory 12 or 22 and executed by the processor 11 or 21. The memory 12 or 22 can be implemented within the processor 11 or 21 or external to the processor 11 or 21 in which case those can be communicatively coupled to the processor 11 or 21 via various means as is known in the art.

In some embodiments, the processor 11 is configured to perform at least one of the followings: a transmission of a first signal and/or a second signal from and/or to a network device; a positioning measurement based on the first signal and/or the second signal; or reporting an assistance information to the network device. This can provide a system positioning, reduce a network signaling, reduce a power consumption, provide a good communication performance, and/or provide a high reliability.

In some embodiments, the processor 21 is configured to perform at least one of the followings: a transmission of a first signal and/or a second signal from and/or to a user equipment (UE); a positioning measurement based on the first signal and/or the second signal; or detecting an assistance information reported by the UE. This can provide a system positioning, reduce a network signaling, reduce a power consumption, provide a good communication performance, and/or provide a high reliability.

FIG. 5 illustrates a method 500 of wireless communication by a UE according to an embodiment of the present disclosure. In some embodiments, the method 500 includes: a block 502, performing, by the UE, a transmission of a first signal and/or a second signal from and/or to a network device; or a block 504, performing, by the UE, a positioning measurement based on the first signal and/or the second signal; or a block 506, reporting, by the UE, an assistance information to the network device. This can provide a system positioning, reduce a network signaling, reduce a power consumption, provide a good communication performance, and/or provide a high reliability.

FIG. 6 illustrates a method 600 of wireless communication by a network device according to an embodiment of the present disclosure. In some embodiments, the method 600 includes: a block 602, performing, by the network device, a transmission of a first signal and/or a second signal from and/or to a user equipment (UE); a block 604, performing, by the network device, a positioning measurement based on the first signal and/or the second signal; or a block 606, detecting, by the network device, an assistance information reported by the UE. This can provide a system positioning, reduce a network signaling, reduce a power consumption, provide a good communication performance, and/or provide a high reliability.

The examples given in this disclosure can be applied for IoT device or NB-IoT UE in NTN systems, but the method is not exclusively restricted to NTN system nor for IoT devices or NB-IoT UE. The examples given in this disclosure can be applied for NR systems, LTE systems, or NB-IoT systems. Further, some examples in the present disclosure can be applied for NB-IoT system, the PDCCH is equivalent to NB-PDCCH (NPDCCH) and the PDSCH is equivalent to NB-PDSCH (NPDSCH).

### EXAMPLE

In this disclosure, some examples present a method for NTN system positioning using DL-TDOA method. The key aspect of examples may include 1) TRP associate with satellite, 2) UE reporting RSTD2 instead of RSTD1, 3) The method for calculating RSTD2, and/or 4) UE reporting timestamp according to an uplink synchronization reference point timing.

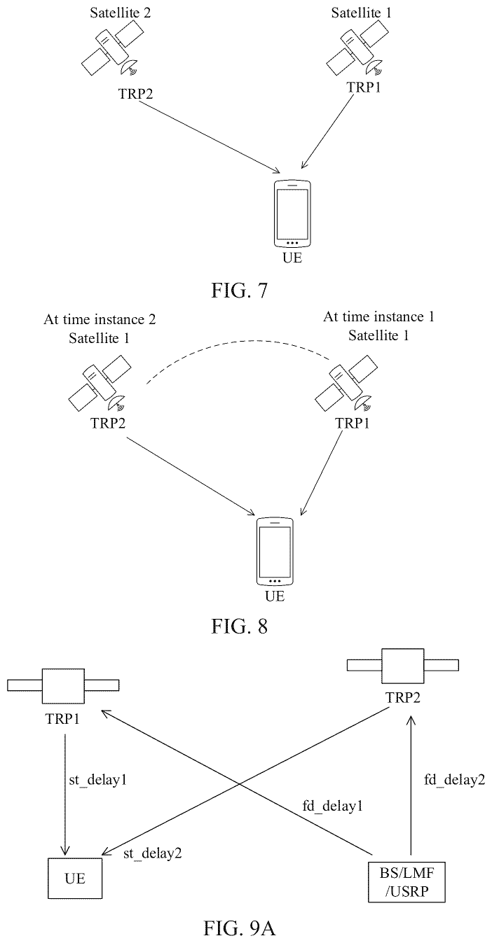

In an NTN system, a TRP may be one satellite and multiple TRPs may be multiple satellites, as illustrated in FIG. 7, optionally, multiple TRPs can also be realized by one satellite, and the satellite at a time instance (or called a time period or a time interval) may be considered as a TRP, thus, the satellite at different time instances may be considered as multiple TRPs as illustrated in FIG. 8. In the following, the presented exemplary method can be applied for one satellite case or multiple satellite case.

Following the legacy DL-TDOA principle, the UE may measure a time delay of arrival difference between two TRPs. In an NTN system with a deployment transparent load, a satellite is used to forward a signal from a base station on ground to a UE or the other way around. Then the signal following two links, i.e., a feeder link and a service link. The feeder link connects the base state/an uplink synchronization reference point (according to TS 38.211 V17.1.0 section 4.1) and the satellite, and the service link connects the satellite and the UE.

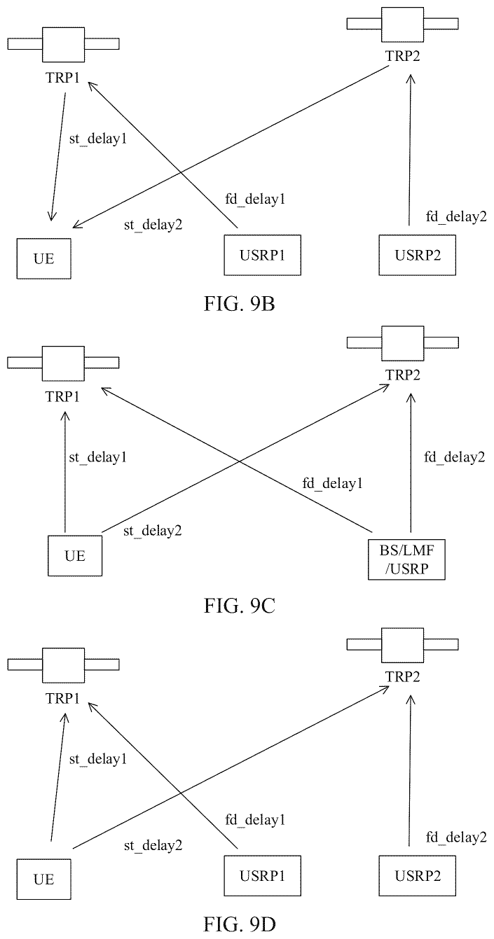

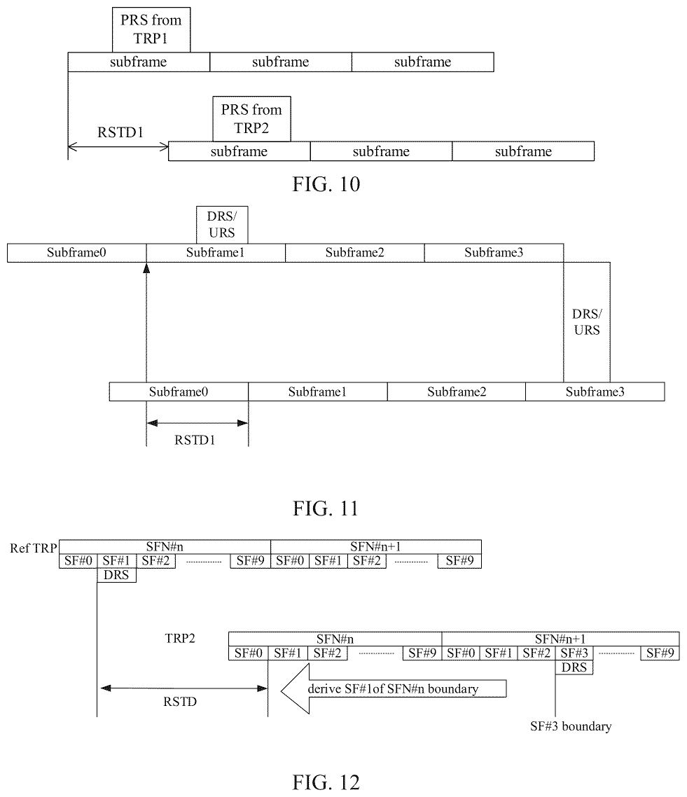

As illustrated in FIG. 9A, when an LMF is installed on the ground, the base state sends a positioning reference signal (PRS) to a satellite, and the satellite then forwards the PRS to a UE. In this case, when the UE receives a PRS from the satellite or from a TRP1, the PRS experiences the delay including a feeder link delay (Fd_delay1) and a service link delay (SL_delay1). When the UE receives another PRS from a TRP2, the PRS experiences Fd_delay2 and SL_delay2. Thus, when the UE calculates the time delay of arrival difference, it turns out that RSTD1=Fd_delay2-Fd_delay1+SL_delay2-SL_delay1 as illustrated in FIG. 10. However, since the TRP is on the satellite side, the RSTD only counts for the TDOA between TRP and UE. For this reason, the UE calculates only RSTD2=SL_delay2-SL_delay1. Thus, the UE reports the RSTD2 to the LMF and to calculate the RSTD2. The UE can do the procedures as follows:

In one step, when the UE receives a first PRS from the TRP1, the UE determines a first subframe or slot using the received the first PRS. Then, when the UE receives a second PRS from the TRP2, the UE determines a second subframe or slot using the received the second PRS. The value of RSTD1 is calculated by the time difference between the start of the first subframe and the start of the second subframe.

In another step, the UE determines the value of Fd_delay2-Fd_delay1 by separately determining the value of Fd_delay2 and Fd_delay1, then the UE calculates the value of Fd_delay2-Fd_delay1. The Fd_delay1 is the feeder link delay for TRP1. To calculate the Fd_delay1, the UE may use first one or more parameters provided by the network (such as a core network or a base station) or LMF and/or a first reference time instance to calculate the Fd_delay1. The first reference time instance may be provided by the LMF or the network. In some examples, the first reference time instance is based on the uplink synchronization reference point (or called USRP or RP for short), the uplink synchronization reference point is defined in section 4.1 of TS38.211 V17.1.0. Optionally, the first reference time instance is determined by the UE, where the first reference time instance corresponds to a time instance when the UE receives the first PRS from the TRP1. To calculate the Fd_delay2, the UE may use second one or more parameters provided by the network or LMF and/or a second reference time instance to calculate the Fd_delay2. The second reference time instance may be provided by the LMF or the network. In some examples, the second reference time instance is based on the uplink synchronization reference point. Optionally, the second reference time instance is determined by the UE, where the second reference time instance corresponds to a time instance when the UE receives the second PRS from the TRP2. In some examples, the first one or more parameters are same as the second one or more parameters. For example, when the TRP1 and TRP2 are both from the same satellite, the first one or more parameters are same as the second one or more parameters.

In a third step, the UE calculates the RSTD2, which is based on RSTD1 while subtracting the difference between Fd_delay2 and Fd_delay1, i.e., RSTD2=RSTD1-(Fd_delay2-Fd_delay1). The UE may report the RSTD2 to the LMF.

The operation mechanism of FIG. 9B is similar to the operation mechanism of FIG. 9A, therefore the present disclosure will not repeat the above steps and contents. The difference is that FIG. 9B illustrates that, in some examples, the Fd_delay1 is the feeder link delay for TRP1 from USRP1, and the Fd_delay2 is the feeder link delay for TRP2 from USRP2.

Further, the operation mechanism of FIG. 9C is similar to the operation mechanism of FIG. 9A, therefore the present disclosure will not repeat the above steps and contents. The difference is that FIG. 9C illustrates that, in some examples, the UE transmits a first DRS/URS to the satellite or from a TRP1, and the UE transmits a second DRS/URS to the satellite or from a TRP2. Further, the operation mechanism of FIG. 9D is similar to the operation mechanism of FIG. 9B, therefore the present disclosure will not repeat the above steps and contents. The difference is that FIG. 9D illustrates that, in some examples, the UE transmits a first DRS/URS to the satellite or from a TRP1, and the UE transmits a second DRS/URS to the satellite or from a TRP2.

Optionally, the UE may also report a time stamp to the LMF, where the time stamp refers to a time instance when the UE calculates the RSTD2. The time stamp may be a UTC time or may be a SFN index and/or a slot index. When the time stamp is a SFN index and/or a slot index, the SFN index and/or the slot index are based on the timing at the uplink synchronization reference point.

In some examples, when a UE receives a DRS/URS from a reference TRP (in our sample in FIG. 11, the reference TRP is TRP1) and the UE determines a reference subframe which is the subframe in which the UE receives the DRS/URS (in our examples the reference subframe is subframe #1). Then the UE receives another DRS/URS from the other TRP (TRP2 in our example) and the UE determines a subframe in which the UE receives the DRS/URS (in our example, the subframe #3), the UE determines the subframe 3 boundary and then derives a subframe boundary corresponding the reference subframe index, i.e., subframe #1 as illustrated in FIG. 11. This is the subframe boundary to be used to calculate the RSTD between reference TRP (TRP1) and TRP2 as illustrated in FIG. 11. In some examples as illustrated in FIG. 12, the reference subframe also comprises the SFN index, i.e., the reference subframe is the subframe index in a SFN index where the UE receives the DRS/URS from the reference TRP (subframe #1 of SFN #n in our example). Then UE receives another DRS/URS from the other TRP (TRP2 in our example) and the UE determines a subframe in which the UE receives the DRS/URS (in our example, the subframe #3 in SFN n+1), the UE can determine the subframe 3 boundary and then can derive a subframe boundary corresponding the reference subframe index, i.e. subframe #1 in SFN #n as illustrated in FIG. 12. The RSTD is illustrated in FIG. 12.

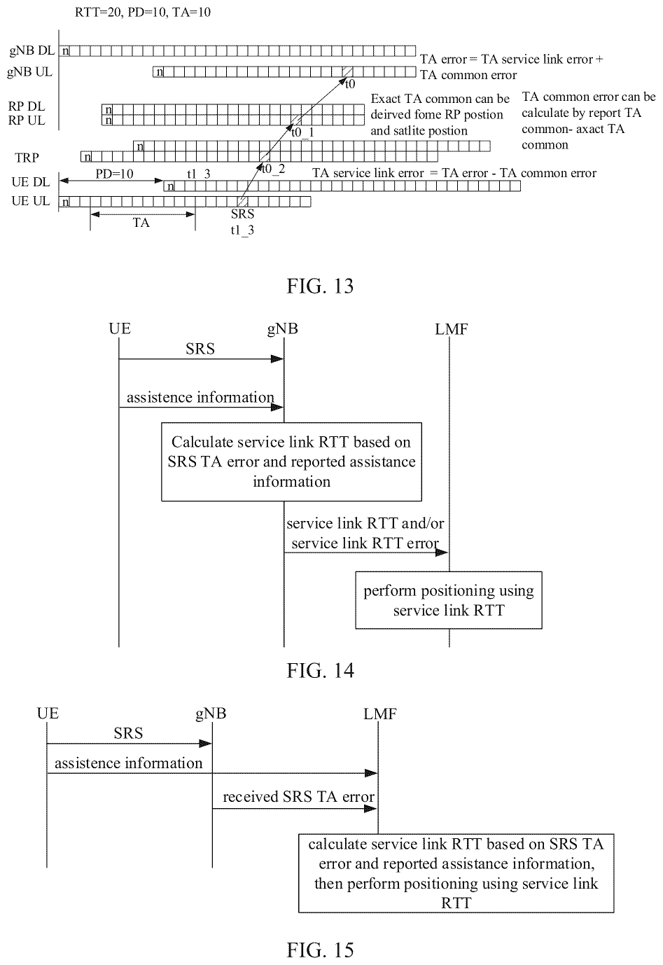

In some examples, the UE transmits an uplink reference signal (such as SRS to the network at time to_3 as illustrated in FIG. 13. Moreover, the UE also reports to the network and/or the LMF with assistance information, where the assistance information can be used by the network to obtain at least two information, i.e., a first information about a first timing advance (TA) corresponding to the service link and the second information about a second TA corresponding to the common TA. The first TA is applied on the SRS transmission intended to compensate for RTT between UE and the satellite (or TRP). The second TA is applied on the SRS transmission too which is intended to compensate for the RTT between the satellite (or TRP) and the uplink synchronization reference point. The assistance information can include the first information and the second information respectively. Or the assistance information may include the first/second information and an offset value, where the second/first information can be derived based on the first/second information and the offset value.

On the gNB side, when it receives the SRS, it can derive the subframe or slot boundary in which the SRS is received and estimate a second offset between the derived subframe boundary and the closest downlink subframe boundary. The gNB may report the second offset to the LMF. Optionally, the second offset refer to the TA error which may be caused by both of the first TA and the second TA. Thus, the gNB may report the first TA error to the LMF as the first TA error represents the service link RTT and it can be used for estimating the positioning as illustrated in FIG. 14. In this case, as the gNB knows the USRP position and the satellite position, it can calculate the exact TA value for the second TA, then the gNB may calculate the second TA error by comparing the exact TA value for the second TA and the reported second TA by UE. Then the gNB may further derive the first TA error by subtracting the second TA error from the second offset. It is to note that the above first TA error calculation can also be performed by LMF, in this case, the gNB may report the USRP position and satellite position to the LMF and the UE assistance information is directly reported to the LMF as illustrated in FIG. 15.

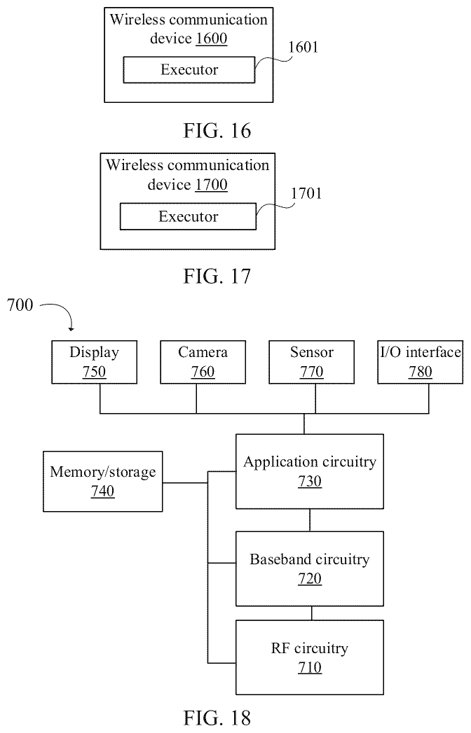

FIG. 16 illustrates a wireless communication device 1600 according to an embodiment of the present disclosure. The wireless communication device 1600 includes an executor 1601 configured to perform at least one of the followings: a transmission of a first signal and/or a second signal from and/or to a network device; a positioning measurement based on the first signal and/or the second signal; or reporting an assistance information to the network device. This can provide a system positioning, reduce a network signaling, reduce a power consumption, provide a good communication performance, and/or provide a high reliability.

FIG. 17 illustrates a wireless communication device 1700 according to an embodiment of the present disclosure. The wireless communication device 1700 includes an executor 1701 configured to perform at least one of the followings: a transmission of a first signal and/or a second signal from and/or to a user equipment (UE); a positioning measurement based on the first signal and/or the second signal; or detecting an assistance information reported by the UE. This can provide a system positioning, reduce a network signaling, reduce a power consumption, provide a good communication performance, and/or provide a high reliability.

In some embodiments, the network device includes a base station, a core network, a transmission reception point (TRP), a satellite, or a location management function (LMF). In some embodiments, the first signal is configured being associated with a first transmission reception point (TRP) and the second signal is configured being associated with a second TRP. In some embodiments, the first TRP is associated with a first satellite and the second TRP is associated with a second satellite or the second TRP is associated with the first satellite. In some embodiments, the first TRP is associated with the first satellite corresponding to a first time, and the second TRP is associated with the first satellite corresponding to a second time, wherein the first time and/or the second time includes a time instance, a time period, or a time interval. In some embodiments, the first signal includes a first downlink reference signal (DRS) and/or a first uplink reference signal (URS), and/or the second signal includes a second DRS or a second URS.

In some embodiments, the DRS includes: a positioning reference signal (PRS), a synchronization signal block (SSB) or a channel state information reference signal (CSI-RS); the URS includes a sounding reference symbol (SRS), a physical random access channel (PRACH), a physical uplink control channel (PUCCH), or a physical uplink shared channel (PUSCH). In some embodiments, performing, by the UE, the transmission of the first signal and/or the second signal from and/or to the network device includes: when the UE receives a DRS from a reference TRP, the UE determines a reference subframe or slot which is a subframe or slot in which the UE receives the DRS from the reference TRP. In some embodiments, the UE determines a first subframe index or slot index, wherein the first subframe index or slot index is an index of the reference subframe or slot. In some embodiments, the reference TRP is the first TRP. In some embodiments, performing, by the UE, the transmission of the first signal and/or the second signal from and/or to the network device includes: when the UE receives a second DRS from the second TRP, the UE determines a second subframe or slot in which the UE receives the second DRS.

In some embodiments, performing the positioning measurement based on the first signal and/or the second signal includes: the UE determining a first boundary and a second boundary, wherein the first boundary is a boundary of the reference subframe or slot, and the second boundary is a boundary of a subframe or slot corresponding to the first subframe index or slot index. In some embodiments, the second boundary is determined from a boundary of the second subframe or slot. In some embodiments, the positioning measurement further includes calculating a time difference between the first boundary and the second boundary. In some embodiments, the assistance information is used by the network device to obtain a first information about a first timing advance (TA) corresponding to a service link, a second information about a second TA corresponding to a common TA and/or an offset value. In some embodiments, the first TA and/or the second TA includes one or more TA values, wherein the one or more TA values correspond to the applied TA at different time instances. In some embodiments, the first TA is applied on the first URS transmission used to compensate for round trip time (RTT) between the UE and a satellite or a TRP); the second TA is applied on the first URS transmission used to compensate for the RTT between the satellite or TRP and an uplink synchronization reference point.

In some embodiments, the first information is derived based on the second information and the offset value; and/or the second information is derived based on the first information and the offset value. In some embodiments, the network device derives a subframe or slot boundary in which the first URS is received by the network device; and/or a second offset is estimated by the network device between the derived subframe or slot boundary and a closest downlink subframe or slot boundary closest to the derived subframe or slot boundary. In some embodiments, the second offset is reported from a base station to an LMF. In some embodiments, the second offset refers to a TA error caused by the first TA and/or the second TA. In some embodiments, the TA error is a time difference between a boundary of an uplink subframe and a boundary of a downlink subframe; and/or the downlink subframe overlaps with the uplink subframe or the downlink subframe overlaps with the uplink subframe with a delay.

In some embodiments, a first TA error is reported by the base station to the LMF or calculated by the base station or the LMF as the first TA error represents a service link RTT and/or the first TA error is used for estimating positioning. In some embodiments, an exact TA value for the second TA is calculated by the base station or the LMF using a USRP position and a satellite position; and/or a second TA error is calculated by the base station or the LMF by comparing the exact TA value for the second TA and the reported second TA by the UE. In some embodiments, the first TA error is derived by the base station by subtracting the second TA error from the second offset. In some embodiments, the USRP position and the satellite position is reported by the base station to the LMF.

Commercial interests for some embodiments are as follows. 1. Providing a system positioning. 2. Reducing a network signaling. 3. Reducing a power consumption. 4. Providing a good communication performance. 5. Providing a high reliability. 6. Some embodiments of the present disclosure are used by 5G-NR chipset vendors, V2X communication system development vendors, automakers including cars, trains, trucks, buses, bicycles, moto-bikes, helmets, and etc., drones (unmanned aerial vehicles), smartphone makers, communication devices for public safety use, AR/VR device maker for example gaming, conference/seminar, education purposes. Some embodiments of the present disclosure are a combination of “techniques/processes” that can be adopted in 3GPP specification to create an end product. Some embodiments of the present disclosure could be adopted in 5G NR licensed and non-licensed or shared spectrum communications. Some embodiments of the present disclosure propose technical mechanisms.

FIG. 18 is a block diagram of an example system 700 for wireless communication according to an embodiment of the present disclosure. Embodiments described herein may be implemented into the system using any suitably configured hardware and/or software. FIG. 18 illustrates the system 700 including a radio frequency (RF) circuitry 710, a baseband circuitry 720, an application circuitry 730, a memory/storage 740, a display 750, a camera 760, a sensor 770, and an input/output (I/O) interface 780, coupled with each other at least as illustrated. The application circuitry 730 may include a circuitry such as, but not limited to, one or more single-core or multi-core processors. The processors may include any combination of general-purpose processors and dedicated processors, such as graphics processors, application processors. The processors may be coupled with the memory/storage and configured to execute instructions stored in the memory/storage to enable various applications and/or operating systems running on the system.

The baseband circuitry 720 may include circuitry such as, but not limited to, one or more single-core or multi-core processors. The processors may include a baseband processor. The baseband circuitry may handle various radio control functions that enables communication with one or more radio networks via the RF circuitry. The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry may support communication with an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry.

In various embodiments, the baseband circuitry 720 may include circuitry to operate with signals that are not strictly considered as being in a baseband frequency. For example, in some embodiments, baseband circuitry may include circuitry to operate with signals having an intermediate frequency, which is between a baseband frequency and a radio frequency. The RF circuitry 710 may enable communication with wireless networks using modulated electromagnetic radiation through a non-solid medium. In various embodiments, the RF circuitry may include switches, filters, amplifiers, etc. to facilitate the communication with the wireless network. In various embodiments, the RF circuitry 710 may include circuitry to operate with signals that are not strictly considered as being in a radio frequency. For example, in some embodiments, RF circuitry may include circuitry to operate with signals having an intermediate frequency, which is between a baseband frequency and a radio frequency.

In various embodiments, the transmitter circuitry, control circuitry, or receiver circuitry discussed above with respect to the user equipment, eNB, or gNB may be embodied in whole or in part in one or more of the RF circuitry, the baseband circuitry, and/or the application circuitry. As used herein, “circuitry” may refer to, be part of, or include an Application Specific Integrated Circuit (ASIC), an electronic circuit, a processor (shared, dedicated, or group), and/or a memory (shared, dedicated, or group) that execute one or more software or firmware programs, a combinational logic circuit, and/or other suitable hardware components that provide the described functionality. In some embodiments, the electronic device circuitry may be implemented in, or functions associated with the circuitry may be implemented by, one or more software or firmware modules. In some embodiments, some or all of the constituent components of the baseband circuitry, the application circuitry, and/or the memory/storage may be implemented together on a system on a chip (SOC). The memory/storage 740 may be used to load and store data and/or instructions, for example, for system. The memory/storage for one embodiment may include any combination of suitable volatile memory, such as dynamic random access memory (DRAM)), and/or non-volatile memory, such as flash memory.

In various embodiments, the I/O interface 780 may include one or more user interfaces designed to enable user interaction with the system and/or peripheral component interfaces designed to enable peripheral component interaction with the system. User interfaces may include, but are not limited to a physical keyboard or keypad, a touchpad, a speaker, a microphone, etc. Peripheral component interfaces may include, but are not limited to, a non-volatile memory port, a universal serial bus (USB) port, an audio jack, and a power supply interface. In various embodiments, the sensor 770 may include one or more sensing devices to determine environmental conditions and/or location information related to the system. In some embodiments, the sensors may include, but are not limited to, a gyro sensor, an accelerometer, a proximity sensor, an ambient light sensor, and a positioning unit. The positioning unit may also be part of, or interact with, the baseband circuitry and/or RF circuitry to communicate with components of a positioning network, e.g., a global positioning system (GPS) satellite.

In various embodiments, the display 750 may include a display, such as a liquid crystal display and a touch screen display. In various embodiments, the system 700 may be a mobile computing device such as, but not limited to, a laptop computing device, a tablet computing device, a netbook, an ultrabook, a smartphone, an AR/VR glasses, etc. In various embodiments, system may have more or less components, and/or different architectures. Where appropriate, methods described herein may be implemented as a computer program. The computer program may be stored on a storage medium, such as a non-transitory storage medium.

In an aspect of the present disclosure, a non-transitory machine-readable storage medium has stored thereon instructions that, when executed by a computer, cause the computer to perform the above method.

In an aspect of the present disclosure, a chip includes a processor, configured to call and run a computer program stored in a memory, to cause a device in which the chip is installed to execute the above method.

In an aspect of the present disclosure, a computer readable storage medium, in which a computer program is stored, causes a computer to execute the above method.

In an aspect of the present disclosure, a computer program product includes a computer program, and the computer program causes a computer to execute the above method.

In an aspect of the present disclosure, a computer program causes a computer to execute the above method.

A person having ordinary skill in the art understands that each of the units, algorithm, and steps described and disclosed in the embodiments of the present disclosure are realized using electronic hardware or combinations of software for computers and electronic hardware. Whether the functions run in hardware or software depends on the condition of application and design requirement for a technical plan. A person having ordinary skill in the art can use different ways to realize the function for each specific application while such realizations should not go beyond the scope of the present disclosure. It is understood by a person having ordinary skill in the art that he/she can refer to the working processes of the system, device, and unit in the above-mentioned embodiment since the working processes of the above-mentioned system, device, and unit are basically the same. For easy description and simplicity, these working processes will not be detailed.

It is understood that the disclosed system, device, and method in the embodiments of the present disclosure can be realized with other ways. The above-mentioned embodiments are exemplary only. The division of the units is merely based on logical functions while other divisions exist in realization. It is possible that a plurality of units or components are combined or integrated in another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms.

The units as separating components for explanation are or are not physically separated. The units for display are or are not physical units, that is, located in one place or distributed on a plurality of network units. Some or all of the units are used according to the purposes of the embodiments. Moreover, each of the functional units in each of the embodiments can be integrated in one processing unit, physically independent, or integrated in one processing unit with two or more than two units.

If the software function unit is realized and used and sold as a product, it can be stored in a readable storage medium in a computer. Based on this understanding, the technical plan proposed by the present disclosure can be essentially or partially realized as the form of a software product. Or, one part of the technical plan beneficial to the conventional technology can be realized as the form of a software product. The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a read-only memory (ROM), a random access memory (RAM), a floppy disk, or other kinds of media capable of storing program codes.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

1. A wireless communication method by a user equipment (UE), comprising at least one of the followings:
performing, by the UE, a transmission of a first signal and/or a second signal from and/or to a network device;
performing, by the UE, a positioning measurement based on the first signal and/or the second signal; or
reporting, by the UE, an assistance information to the network device.

2. The method of claim 1, wherein performing, by the UE, the transmission of the first signal and/or the second signal from and/or to the network device comprises:
when the UE receives a downlink reference signal (DRS) from a reference transmission reception point (TRP), the UE determines a reference subframe or slot which is a subframe or slot in which the UE receives the DRS from the reference TRP.

3. The method of claim 2, wherein the UE determines a first subframe index or slot index, wherein the first subframe index or slot index is an index of the reference subframe or slot; and/or the reference TRP is a first TRP.

4. The method of claim 1, wherein the assistance information is used by the network device to obtain a first information about a first timing advance (TA) corresponding to a service link, a second information about a second TA corresponding to a common TA and/or an offset value.

5. The method of claim 4, wherein the first TA and/or the second TA comprises one or more TA values, wherein the one or more TA values correspond to an applied TA at different time instances; and/or the first TA is applied on a first uplink reference signal (URS) transmission used to compensate for round trip time (RTT) between the UE and a satellite or a TRP; the second TA is applied on the first URS transmission used to compensate for the RTT between the satellite or TRP and an uplink synchronization reference point; and/or the first information is derived based on the second information and the offset value; and/or the second information is derived based on the first information and the offset value.

6. The method of claim 4, wherein a second offset is reported from a base station to a location management function (LMF); and/or the second offset refers to a TA error caused by the first TA and/or the second TA.

7. A wireless communication method by a network device, comprising at least one of the followings:
performing, by the network device, a transmission of a first signal and/or a second signal from and/or to a user equipment (UE);
performing, by the network device, a positioning measurement based on the first signal and/or the second signal; or
detecting, by the network device, an assistance information reported by the UE.

8. The method of claim 7, wherein the network device comprises a base station, a core network, a transmission reception point (TRP), a satellite, or a location management function (LMF).

9. The method of claim 7, wherein the assistance information is used by the network device to obtain a first information about a first timing advance (TA) corresponding to a service link, a second information about a second TA corresponding to a common TA and/or an offset value.

10. The method of claim 9, wherein a second offset is reported from a base station to an LMF;
and/or the second offset refers to a TA error caused by the first TA and/or the second TA.

11. The method of claim 10, wherein the TA error is a time difference between a boundary of an uplink subframe and a boundary of a downlink subframe; and/or the downlink subframe overlaps with the uplink subframe or the downlink subframe overlaps with the uplink subframe with a delay;
a first TA error is reported by the base station to the LMF or calculated by the base station or the LMF, the first TA error represents a service link RTT and/or the first TA error is used for estimating positioning; and/or
an exact TA value for the second TA is calculated by the base station or the LMF using an uplink synchronization reference point (USRP) position and a satellite position; and/or a second TA error is calculated by the base station or the LMF by comparing the exact TA value for the second TA and a reported second TA by the UE.

12. The method of claim 11, wherein the first TA error is derived by the base station by subtracting the second TA error from the second offset; and/or the USRP position and the satellite position is reported by the base station to the LMF.

13. A user equipment (UE), comprising:
a memory;
a transceiver; and
a processor coupled to the memory and the transceiver;
wherein the processor is configured to perform at least one of the followings:
a transmission of a first signal and/or a second signal from and/or to a network device;
a positioning measurement based on the first signal and/or the second signal; or
reporting an assistance information to the network device.

14. The UE of claim 13, wherein the first signal is configured being associated with a first transmission reception point (TRP) and the second signal is configured being associated with a second TRP.

15. The UE of claim 14, wherein the first TRP is associated with a first satellite and the second TRP is associated with a second satellite or the second TRP is associated with the first satellite.

16. The UE of claim 14, wherein the first TRP is associated with a first satellite corresponding to a first time, and the second TRP is associated with the first satellite corresponding to a second time, wherein the first time and/or the second time comprises a time instance, a time period, or a time interval.

17. The UE of claim 14, wherein the first signal comprises a first downlink reference signal (DRS) and/or a first uplink reference signal (URS), and/or the second signal comprises a second DRS or a second URS.

18. The UE of claim 17, wherein the DRS comprises: a positioning reference signal (PRS), a synchronization signal block (SSB), or a channel state information reference signal (CSI-RS); and/or the URS comprises a sounding reference symbol (SRS), a physical random access channel (PRACH), a physical uplink control channel (PUCCH), or a physical uplink shared channel (PUSCH).

19. The UE of claim 17, wherein the processor is further configured to:
when the UE receives the second DRS from the second TRP, determine a second subframe or slot in which the UE receives the second DRS; and/or
determine a first boundary and a second boundary, wherein the first boundary is a boundary of a reference subframe or slot, and the second boundary is determined from a boundary of the second subframe or slot.

20. The UE of claim 19, wherein the positioning measurement further comprises calculating a time difference between the first boundary and the second boundary.
